(19) United States
(12) Patent Application Publication
(10) Pub. No.: US 2014/0356566 A1
(43) Pub. Date: Dec. 4, 2014

(54) MULTI-LAYER POLYOLEFIN FILMS AND USES THEREOF

(71) Applicant: Achilles USA, Inc., Everett, WA (US)

(72) Inventors: Bach Nguyen, Everett, WA (US); Takuo Suzuki, Everett, WA (US)

(73) Assignee: Achilles USA, Inc., Everett, WA (US)

(21) Appl. No.: 14/289,327

(22) Filed: May 28, 2014

Related U.S. Application Data
(60) Provisional application No. 61/828,100, filed on May 28, 2013.

(51) Int. Cl. B32B 27/32; B29C 43/24; B29C 47/06; B29C 71/04; B32B 27/30; B32B 3/30

(52) U.S. Cl. CPC B32B 27/32; B32B 27/304; B32B 3/30; B29C 47/065; B29C 71/04; B29C 43/24; B29C 47/068; B32B 2250/03; B32B 2307/406; B32B 2307/744; B32B 2439/70; B32B 2307/70; B32B 2327/06; B32B 2323/10; B29K 2023/12
USPC 428/40.6; 428/215; 428/141; 428/156; 264/173.12; 264/469

(57) ABSTRACT

Polyolefin films comprising a gloss layer, a matte layer and a support layer are provided. Use of the polyolefin films as a carrier material for self-clinging films and polyolefin films adhered to self-clinging films are also provided.

### BACKGROUND

1. Field of the Invention

The present invention is generally directed to polyolefin films, methods for making the films and methods for use of the same.

2. Description of the Related Art

Polyvinyl chloride (“PVC”) is made by the polymerization and copolymerization of polyvinylchloride and other monomers. PVC has been used for a number of years in the manufacture of soft, flexible films for food packaging, in molded rigid products (such as pipes, fibers, upholstery and bristles), and in a variety of other products, including electric wire and cable-coverings, film finishes for textiles, raincoats, belting, gaskets and shoe soles. Self-clinging films can also be prepared from PVC polymers. PVC self-clinging films have been used in a number of applications, including window decorations and privacy glass.

PVC self-clinging films have been prepared by introducing a carrier sheet during the calendering process, thus producing a PVC film in intimate contact with (i.e., removably laminated to) a removable carrier sheet. Ideally, the removable carrier sheet and the self-clinging films have compatible surface tensions, such that the carrier sheet can be removed from the self-clinging film after extended storage periods, and the self-clinging properties of the film do not degrade over time (e.g., by leaching or transfer of plasticizers or other additives between the two films). Paper (e.g., coated with chrome or polyethylene) and polyester (e.g., polyethylene terephthalate) have both been used as casting sheets for preparation of self-clinging films; however, these types of materials have disadvantages. For example, paper carrier sheets typically require use of a wax release agent to ensure that the self-clinging film can be separated from the carrier sheet, and upon storage these wax release agents tend to degrade the self-clinging surface of the PVC film. Further, both paper and polyester are heavy and tend to cause self-clinging films to degrade (e.g., decrease in surface tension, increase in haziness, etc.) at the temperatures useful for certain manufacturing processes, such as embossing.

Accordingly, there is a need in the art for improved material for use as removable carrier sheets during the preparation of self-clinging films. The present invention provides this and other related advantages.

### BRIEF SUMMARY

In brief, the present invention is generally directed to polyolefin films. Typically the polyolefin films comprise three different polyolefin layers. A first layer will generally have an outer surface with high gloss, and a second layer will typically have an outer surface with low gloss. Interposed between the first and second layers is a support layer, which can be tailored to provide the desired physical properties to the film. The support layer can be prepared from recycled polyolefin materials, thus reducing the cost and environmental impact of the films. Advantageously, certain embodiments provide polyolefin films wherein at least one surface (e.g., the high gloss surface) has a surface tension compatible with the surface tension of a self-clinging PVC film. Accordingly, the present films find utility in a number of applications, including for use as a casting sheet during preparation, shipping and storage of self-clinging PVC films.

Accordingly, in one embodiment, the present disclosure provides a polyolefin film comprising:
A) a first polyolefin layer having an outer surface with a gloss of greater than about 60 gloss units;
B) a second polyolefin layer having an outer surface with a gloss of less than about 25 gloss units; and
C) a polyolefin support layer interposed between the first and second polyolefin layers,

wherein the polyolefin film has a total thickness ranging from about 0.005 inches to about 0.015 inches, and the thickness of each of the first and second polyolefin layers independently ranges from about 1% to about 20% of the total thickness of the polyolefin film.

Methods for preparation of the polyolefin films are also provided. For example in one embodiment the present disclosure provides a method for preparing the disclosed polyolefin films, the method comprising:

A) co-extruding first, second and third polyolefin compositions onto a die head block; and

C) casting the co-extruded mixture to obtain the polyolefin film.

Use of the polyolefin films as a casting sheet for self-clinging films is also provided. Accordingly, in another embodiment, the present invention is directed to an article comprising any one of the disclosed polyolefin films in contact with a polyvinyl chloride film, wherein:

A) the polyvinyl chloride film comprises a self-clinging surface; and

B) the first outer surface (i.e., the high gloss surface) of the polyolefin film is in contact with the self clinging surface of the polyvinyl chloride film.

Other embodiments are directed to a method for preparing the foregoing article, the method comprising:

A) providing any of the disclosed the polyolefin films;

B) extruding a composition comprising polyvinyl chloride onto a calendering head;

C) calendering the extruded composition to obtain a polyvinyl chloride film; and

D) contacting the polyolefin film with the extruded composition either during or after step C).

In various other embodiments, the present invention provides a self-clinging polymer film comprising first and second outer surfaces, wherein the first outer surface has a gloss of greater than about 75 gloss units, and the second outer surface comprises raised or recessed relief images, designs or patterns, or combinations thereof, wherein the polymer film comprises a polyvinyl chloride polymer comprising at least about 25% plasticizer content by weight.

These and other aspects of the invention will be apparent upon reference to the following detailed description. To this end, various references are set forth herein which describe in more detail certain background information, procedures, compounds and/or compositions, and are each hereby incorporated by reference in their entirety.

### BRIEF DESCRIPTION OF THE DRAWINGS

In the figures, identical reference numbers identify similar elements. The sizes and relative positions of elements in the figures are not necessarily drawn to scale and some of these elements are arbitrarily enlarged and positioned to improve figure legibility. Further, the particular shapes of the elements as drawn are not intended to convey any information regarding the actual shape of the particular elements, and have been solely selected for ease of recognition in the figures.

FIG. 1 depicts a multi-layer polyolefin film according to one embodiment.

FIG. 2 shows an exemplary process for preparing the polyolefin films.

FIG. 3 illustrates an exemplary process for use of the polyolefin films as carrier sheets.

### DETAILED DESCRIPTION

### Definitions

In the following description, certain specific details are set forth in order to provide a thorough understanding of various embodiments of the invention. However, one skilled in the art will understand that the invention may be practiced without these details.

Unless the context requires otherwise, throughout the present specification and claims, the word “comprise” and variations thereof, such as, “comprises” and “comprising” are to be construed in an open, inclusive sense, that is, as “including, but not limited to”.

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

“Polyolefin” refers to a polymer prepared from one or more olefins. Polyolefins include straight-chain polymers, branched polymers, cross-linked polymers, co-polymers, random co-polymers, block co-polymers and the like. Polyolefins may include optional co-monomers and/or plasticizer(s) and/or stabilizer(s). Polyolefins also include in-part polymers, for example propylene co-polymerized with rubber). Representative polyolefins include, but are not limited to: polyethylene, polypropylene, polybutene, and copolymers thereof. Unless stated otherwise specifically in the specification, a polyolefin may be optionally substituted.

“Polyvinyl chloride” or “PVC” refers to polymers prepared from vinyl chloride and optional co-monomers and/or plasticizer(s) and/or stabilizer(s). Copolymers of polyvinyl chloride are formed by the copolymerization of polyvinyl chloride and other monomers or monomer blends.

“Co-monomers” refer to polymer subunits which may be polymerized with other co-monomers to form a polymer. Suitable co-monomers include, but are not limited to, olefins, vinyl acetate, ethylene, propylene, maleate, methacrylate, acrylate, high alcohol vinyl ester, urethane, chlorinated urethane, methylmethacrylate, and mixtures thereof.

“Olefins” are alkyl compounds which contain at least one carbon-carbon double bond. Unless stated otherwise specifically in the specification, an olefin may be optionally substituted.

“Alkyl” refers to a straight or branched hydrocarbon compound consisting solely of carbon and hydrogen atoms, which is saturated or unsaturated (i.e., contains one or more carbon-carbon double and/or triple bonds), having from one to twelve carbon atoms (C₁-C₁₂ alkyl), preferably one to eight carbon atoms (C₁-C₈ alkyl) or one to six carbon atoms (C₁-C₆ alkyl). Representative unsaturated alkyls (e.g. olefins) include, but are not limited to: ethene, propene, butene, pentene, hexene, isoprene and the like. Unless stated otherwise specifically in the specification, an alkyl group may be optionally substituted.

The term “substituted” used herein means any of the above moieties (i.e., polyolefin, olefin and/or alkyl) wherein at least one hydrogen atom is replaced by a bond to a non-hydrogen atoms such as, but not limited to: a halogen atom such as F, Cl, Br, and I; an oxygen atom in groups such as oxo groups (═O), hydroxyl groups (—OH), alkoxy groups (—OR), and ester groups (—C(═O)OR or —OC(═O)R); a nitrogen atom in groups such as amines (—N(R)₂) and amides (—N(═O)R), wherein each R is independently a substituted or unsubstituted alkyl radical.

“Optional” or “optionally” means that the subsequently described event of circumstances may or may not occur, and that the description includes instances where said event or circumstance occurs and instances in which it does not. For example, “optionally substituted alkyl” means that the alkyl may or may not be substituted and that the description includes both substituted alkyls and alkyls having no substitution.

“Self clinging” refers to a property of certain films of the disclosure. A self-clinging film will adhere to a flat surface for an extended period of time without the aid of adhesive. For example, when the film is placed on a glass surface (e.g., windows and the like), it will remain affixed to the surface for an indefinite period of time. Self clinging films generally exhibit a high tackiness (i.e., stickiness) and typically have at least one outer surface with a surface tension ranging from about 30 dynes/cm to about 40 dynes/cm. Self-clinging films will typically comprise from about 25% to about 35% plasticizer based on total weight of the polymer. Certain self-clinging films of the present disclosure comprise PVC polymers.

The term “compatible,” when used in the context of the surface properties (e.g., surface tension) of the described films, refers to the ability of two or more different films to remain in intimate contact for an extended period of time without significant degradation of the properties of either of the films, for example, by leaching of chemicals from one film to another. Compatible film surfaces can remain in intimate contact for periods ranging from one month to one year at temperatures as high as 90° F. or more without significant degradation of either film (e.g., the surface remains suitable for its intended purpose such as self-clinging and/or printing and the like). For example, films of the invention which have compatible surfaces can remain in intimate contact for extended periods of time, yet still remain easily separable and still retain their original self-clinging properties. The surface tensions of compatible surfaces will typically deviate less than 20%, less than 10% or even less than 5% from their original value (i.e., the surface tension before being contacted with the other film), even after extended storage under the conditions described above.

A “polymer” refers to a molecule having one or more repeating subunit. The subunits (“monomers”) may be the same or different and may occur in any position or order within the polymer. Polymers may be of natural or synthetic origin. The present invention includes various types of polymers, including polymers having ordered repeating subunits, random co-polymers and block co-polymers. Polymers having two different monomer types are referred to as co-polymers, and polymers having three different types of monomers are referred to as terpolymers, and so on.

A “random polymer” refers to a polymer wherein the subunits are connected in random order along a polymer chain. Random polymers may comprise any number of different subunits. In certain embodiments, the polymers described herein are “random co-polymers” or “random co-terpolymers”, meaning that the polymers comprise two or three different subunits, respectively, connected in random order. The individual subunits may be present in any molar ratio in the random polymer, for example each subunit may be present in from about 0.1 molar % to about 99.8 molar percent, relative to moles of other subunits in the polymer. In some embodiments, the subunits of a random co-polymer may be represented by the following general structure:

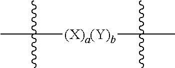

wherein X and Y are independently unique monomer subunits, and a and b are integers representing the number of each subunit within the polymer. For ease of illustration, the above structure depicts a linear connectivity of X and Y; however, it is to be emphasized that random co-polymers (e.g., random co-polymers, random co-terpolymers and the like) of the present invention are not limited to polymers having the depicted connectivity of subunits, and the subunits in a random polymer can be connected in any random sequence, and the polymers can be branched.

A “block co-polymer” refers to a polymer comprising repeating blocks of two or more subunits.

A “thermoplastic polymer” is a polymer is a polymer that becomes pliable or moldable above a specific temperature, and returns to a solid state upon cooling.

A “metallocene polymer” (e.g., metallocene polypropylene) is a polymer prepared by means of a metallocene polymerization catalyst. The exact type of metallocene catalyst used can be selected based on the desired properties of the polymer (e.g., crystalline, amorphous, etc.). Metallocene polymers are well known in the art.

An “impact polymer” is a polymer having high impact resistance. Typically impact polymers will have a lower modulus of elasticity (i.e., less stiff) than non-impact polymers. Exemplary impact polymers include impact polymers comprising polymer chains formed from acrylate, ethylene and/or propylene (or other olefin) monomers. Impact polymers also include certain random polymers as defined above.

A “filler” is a material added to a polymer composition to obtain desired physical characteristics. Fillers are typically inorganic materials, such as calcium carbonate, barium sulfate, talc, magnesium carbonate, and the like. The fillers used herein are typically incorporated in the polymers for increasing and/or optimizing the stiffness or firmness of the polymers.

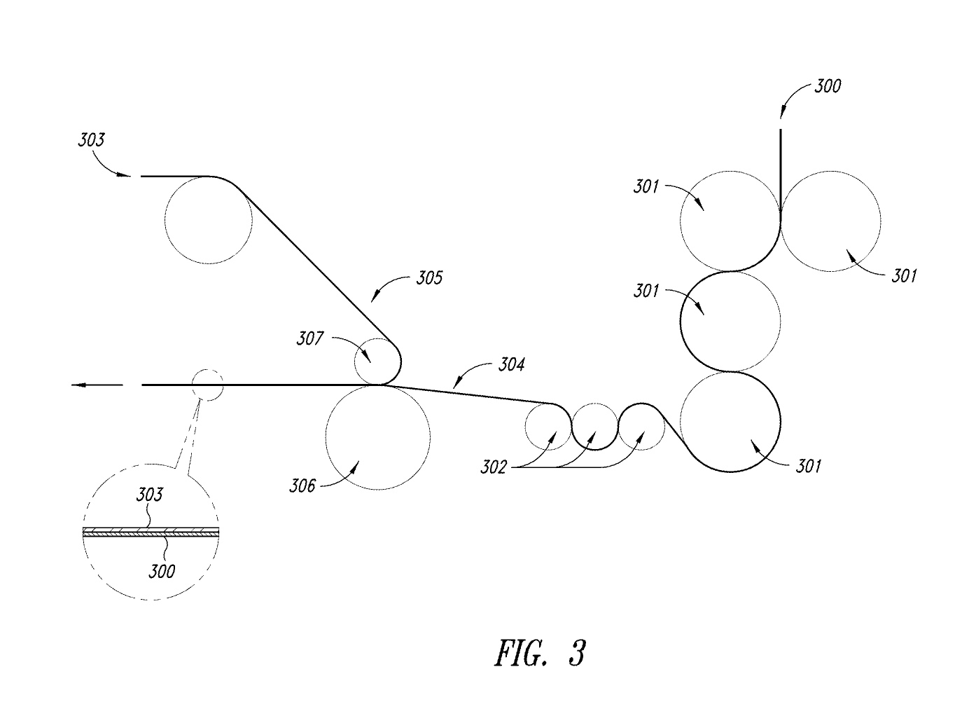

“Embossing” refers to a process in which a pattern is impressed into the surface of an article, such as a film. Embossing typically is accomplished by means of a male pattern formed on a hard material such as a metal layer on an embossing roll, as depicted by in FIG. 3. Those skilled in the art recognize that embossing can be done by several methods, including the use of a continuous tooled belt or sleeve. Preferred metal layers include those comprising nickel, copper, steel, and stainless steel. Patterns typically are machined into the metal layer and can have a wide variety of sizes and shapes. Any pattern that can be scribed into a metal surface can be used in the practice of this invention. “Pattern” does not necessarily refer to a regular repeating array, but may mean a random array of features having the same or different sizes. Patterns suitable for the practice of this invention include four-sided square pyramids, truncated four-sided square pyramids, three-sided triangular pyramids, cones, straight lines, wavy lines, and the like and are machined into at least a portion of the embossing roll. An individual feature of the pattern is referred to as an embossment. The number and spacing of embossments, as well as the nature of the individual embossment, such as its depth, degree of sharp reflecting edges, and shape can be varied as desired. An “embossed” film refers to a film that has been embossed.

### Polyolefin Films and Uses Thereof

As noted above, the present invention generally provides multilayer polyolefin films useful in a variety of applications. In one particular application, the films are employed as carrier sheets for self-cling PVC films. In one advantageous embodiment, the polyolefin films have at least one outer surface which is compatible with the self-clinging surface of PVC films. Accordingly, the polyolefin film can remain in contact with (e.g., removably laminated to) the self-clinging film for extended periods of time with substantially no degradation of either film, and both films remain easily separable so that the self-clinging film can be removed and applied to any number of desired surfaces. Further, since embossing processes often benefit from higher process temperatures, and the polyolefin films are able to withstand higher operational temperatures than previously used carrier sheets (e.g. up to 450° C. or higher compared to about 420° C. for polyethylene terephthalate), the films find particular utility as carrier sheets for embossed self-clinging films.

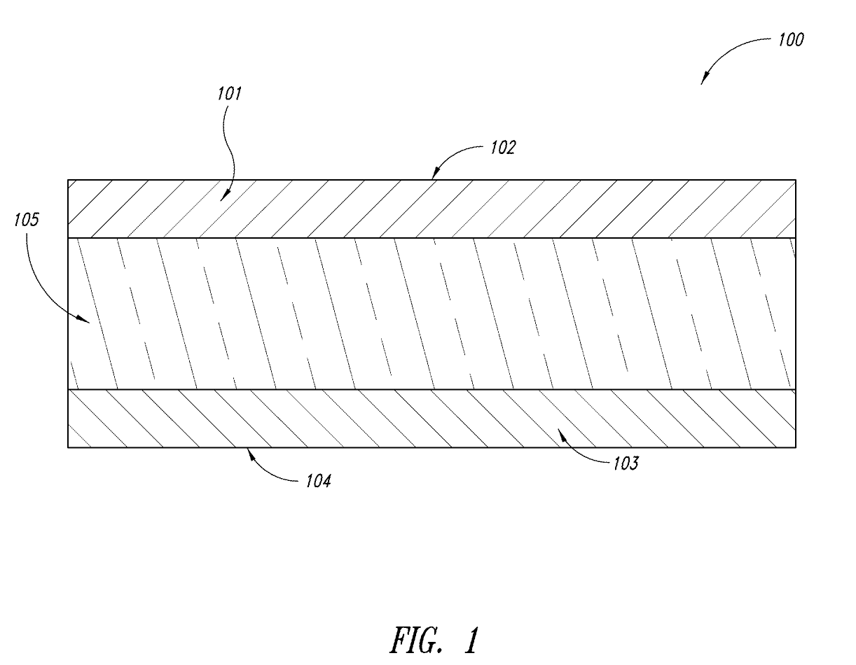

Certain embodiments of the polyolefin films can be better understood in reference to FIG. 1. FIG. 1 depicts a cross-sectional view of an exemplary polyolefin film 100. In the depicted embodiment, the polyolefin film is shown with three layers. The first layer 101, has an outer surface 102 with high gloss. When used as a carrier sheet for self-clinging films, this high gloss surface is the surface which is contacted with the self-clinging surface of the self-clinging film. Certain advantages can be obtained when this high gloss surface is compatible with the self-clinging surface as described below.

The polyolefin films further comprise a second polyolefin layer 103 having an outer surface 104 with low gloss. In some aspects, the polyolefin films can be stored or shipped in rolls or stacks, and the low gloss surface provides a surface with little tackiness so that the rolls can be easily unrolled or the stacks can be easily separated into individual sheets without significant sticking between the layers. For example, when the polyolefin films are used as carrier sheets for self-clinging films, the high gloss surface will be in contact with (e.g., removably laminated to) the self-clinging surface, and when the composite film (i.e., the polyolefin film in contact with the self-clinging film) is rolled or stacked for storage, the low gloss side will be in contact with the non-self-clinging surface of the self-clinging film. Accordingly, the composite film can be easily unrolled and provided for its intended use, even after extended periods of storage.

In this respect, certain embodiments of the invention provide polyolefin films wherein the roughness of the low gloss surface is optimized for use as a carrier sheet for self-clinging films, such as embossed self-clinging films. The present inventors have discovered that films having a low gloss layer with surface roughness in the range of about 1 to about 10 μm are ideal for this purpose. As the roughness of the film decreases below this range, the surface becomes more “sticky” and tends to adhere to other film surfaces when stored in contact with the same. Alternatively, as the surface roughness increases above the ideal range, films stored in contact with the rough surface tend to adopt the three-dimensional characteristics of the surface (i.e., become embossed by contact with the rough surface).

FIG. 1 further depicts a third polyolefin layer 105 interposed between the first and second layers. The exact properties of the third layer (i.e., the “support” layer) can be tailored to the desired end use. For example, the support layer can be provided with structural properties which aid in the storage, transportation and/or disbursement of self-clinging films. Advantageously, certain embodiments provide for use of recycled polyolefin material within the third layer. Such embodiments are described in more detail below.

For ease of illustration, FIG. 1 depicts three different layers of polyolefin; however, it is to be noted that the polyolefin films of the invention are generally considered as one continuous film, rather than three separable films. For example, the polyolefin films are generally prepared by co-extrusion of three polyolefin compositions as described in more detail below. Accordingly, the resulting film comprises three inseperable layers of polyolefin, and each layer will typically have different properties and functions.

Accordingly, in one embodiment the polyolefin film comprises:
A) a first polyolefin layer having an outer surface with a gloss of greater than about 60 gloss units;
B) a second polyolefin layer having an outer surface with a gloss of less than about 25 gloss units; and
C) a polyolefin support layer interposed between the first and second polyolefin layers,

wherein the polyolefin film has a total thickness ranging from about 0.005 inches to about 0.015 inches, and the thickness of each of the first and second polyolefin layers independently ranges from about 1% to about 20% of the total thickness of the polyolefin film.

The thickness of the polyolefin films can vary depending on the desired end use. In one embodiments, the total thickness of the polyolefin film ranges from about 0.007 inches to about 0.011 inches, for example in some specific embodiments the total thickness of the polyolefin film is about 0.008 inches.

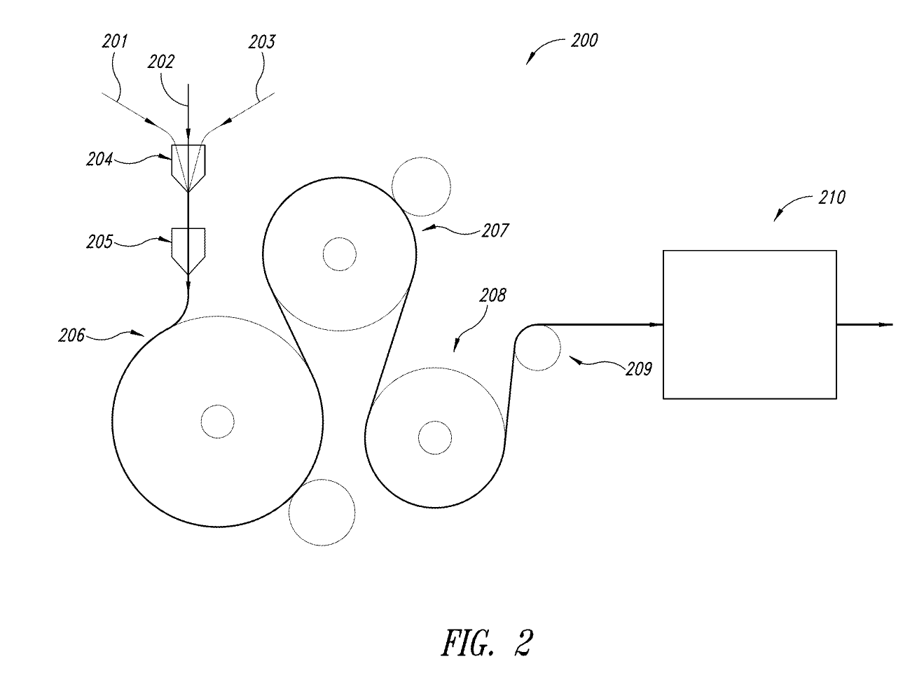

As noted above, the outer surface of the first polyolefin layer can serve as a point of contact between the polyolefin film and a self-clinging film in certain embodiments. Accordingly, the properties of this outer surface can be tailored depending on the desired end use and will typically be compatible with the self-clinging surface of a self-clinging film. For example, when used as a carrier sheet for self-clinging films, a high gloss is generally desired. Gloss can be introduced to a polyolefin film by any number of methods, for example by corona or plasma treatment (see e.g., FIG. 2). The gloss of the polyolefin films can be determined using any number of art-recognized method, for example by use of the BYK gloss meter (ASTM D-2457). In some embodiments, the outer surface of the first polyolefin layer has a gloss (as determined by the BYK gloss meter) ranging from about 60 to about 100 gloss units or from about 70 to about 100 gloss units. In other embodiments, the outer surface of the first polyolefin layer has a gloss of greater than about 65 gloss units, greater than about 70 gloss units, greater than about 75 gloss units or greater than about 80 gloss units.

The properties of the polyolefin films can also be expressed in terms of surface tension. In certain embodiments, the surface tension of the outer surface of the first polyolefin layer is tailored to be compatible with a self-clinging surface of a self-clinging film. In certain embodiments, the first polyolefin layer has a surface tension ranging from about 33 dynes/cm to about 43 dynes/cm as determined by ASTM D 2578. In more embodiments, the outer surface of the first polyolefin layer has a surface tension of greater than about 33 dynes/cm as determined by ASTM D 2578. In still other embodiments, the first polyolefin layer has a surface tension of about 38 dynes/cm as determined by ASTM D 2578.

In certain other embodiments, the first polyolefin layer comprises a random polymer. In some embodiments, the first polyolefin layer comprises an impact polymer, for example a random impact polymer. Such impact polymers include polymers prepared from acrylate, ethylene and or propylene monomers.

The outer surface of the second polyolefin layer advantageously has properties optimized to provide for a non-stick surface such that the polyolefin films can be provided in rolls or stacks (e.g., in contact with a self-clinging film) without undesired adhesion of the film to other surfaces, such as the non-self-clinging surface of a self-clinging film. Accordingly, the outer surface of the second polyolefin layer generally has a low gloss, for example less than about 25 gloss units. In other embodiments, the outer surface of the second polyolefin layer has a gloss of less than about 20 gloss units, less than about 15 gloss units, less than about 10 gloss units or less than about 8 gloss units.

As noted above, the outer surface of the second polyolefin film can be provided with a surface roughness specifically tailored for use as a carrier sheet for self-clinging films. Surface roughness can be measured using techniques commonly employed in the art, such as ASTM D-7127-05. In some embodiments, the outer surface of the second polyolefin layer has a surface roughness ranging from about 1 μm to about 10 μm, for example about 5 μm.

In other embodiments, the polyolefin used for preparation of the second polyolefin layer is varied to obtain the desired properties. For example, in some embodiments the second polyolefin layer comprises a cross-linked polyolefin (e.g., inter-polymer cross-links). In other embodiments, the second polyolefin layer comprises ethylene-propylene rubber (EDPM) and a polypropylene homopolymer. Such compositions can be useful for obtaining the desired surface roughness. In other embodiments, the second polyolefin layer comprises a thermoplastic polyolefin polymer. In still more embodiments, the second polyolefin layer comprises a copolymer of a polyolefin and rubber. Metallocene polymers, such as metallocene polypropylene polymers, are also employed in certain embodiments of the second polyolefin layer.

In some embodiments, the support layer comprises a low density polyethylene. Advantageously, the support (third) polyolefin layer may also comprise recycled polyolefin material, thus reducing the cost and environmental impact of the polyolefin films. Accordingly, in some embodiments, the support layer comprises recycled polyolefin, for example up to about 30% recycled polyolefin. Support layers comprising filler materials for optimization of the physical properties (e.g., stiffness and the like) of the support layer are also provided. For example, in some embodiments the support layer comprises a filler. The filler may be present in up to about 70% by weight of the support layer, for example from about 50% to about 60% by weight. Exemplary fillers include, but are not limited to CaCO₃, clay, BaSO₄, talc and MgCO₃. In certain specific embodiments, the filler is CaCO₃.

The support layer may be provided in any number of colors or tints, or may be opaque. For example, in some embodiments, the support layer includes an additive (i.e., dye) which imparts a white color to the support layer.

The thickness of each of the three polyolefin layers can be independently varied. Typically, the support layer will be the thickest of the three layers, with the first and second layers occupying a minority of the total thickness of the film. In certain embodiments, the thickness of the first polyolefin layer ranges from about 5% to about 15% of the total thickness of the polyolefin film, for example about 10%. In other embodiments, the thickness of the second polyolefin layer ranges from about 1% to about 10% of total thickness of the polyolefin film, for example about 5%. In other related embodiments, the thickness of the polyolefin support layer ranges from about 80% to about 90% of the total thickness of the polyolefin film, for example about 85%.

The polyolefin can be selected from any number of structurally different polyolefins. The first and second layers and the support layer may each comprise the same or different polyolefin. In certain embodiments, at least one of the first polyolefin layer, the second polyolefin layer or the polyolefin support layer comprise polypropylene. In other embodiments, each of the first polyolefin layer, the second polyolefin layer and the polyolefin support layer comprise polypropylene. In various other embodiments, the various layers each comprise the same polyolefin (e.g., polypropylene) but the polyolefin in each layer may independently comprise additional additives (plasticizers, stabilizers, etc.) and/or co-monomers (e.g., ethylene and the like) such that the independent layers have the desired properties.

One embodiment of the present disclosure provides an article (i.e., a composite film) comprising the any one of the foregoing polyolefin films in contact with (e.g., removably laminated to) a polyvinyl chloride film, wherein:

A) the polyvinyl chloride film comprises a self-clinging first outer surface; and

B) the first outer surface of the polyolefin film is in contact with the self clinging surface of the polyvinyl chloride film.

In this respect, the polyolefin films serve as a carrier sheet for the self-clinging films. The polyolefin films are thus generally employed during the manufacture, storage and shipping of the self-clinging films. When desired, the polyolefin films can be easily removed from the self-clinging film and the self-clinging film will retain substantially all of its original properties upon extended periods of time in contact with the polyolefin film. For example, in some embodiments the outer surface of the first polyolefin film and the self-clinging surface of the polyvinyl chloride film have compatible surface tensions. The surface tension of the self-clinging surface of the polyvinyl chloride film generally ranges from about 30 dynes/cm to about 38 dynes/cm, for example about 34 dynes/cm.

In some embodiments, the polyvinyl chloride film further comprises a second outer surface comprising raised or recessed relief images, designs or patterns, or combinations thereof (i.e., embossed surface). This second outer surface is typically not a self-clinging surface. In other embodiments, the article is in the form of a cylindrical roll. For example, in certain specific embodiments, the polyvinyl chloride film comprises an embossed surface, and the article is in the form of a cylindrical roll, such that the embossed surface is in contact with the second outer surface of the polyolefin film.

The self-clinging films may be any novel or known self-clinging film. In some embodiments, the self-clinging film is a self-clinging polymer film comprising first and second outer surfaces, wherein the first outer surface has a gloss of greater than about 75 gloss units, and the second outer surface comprises raised or recessed relief images, designs or patterns, or combinations thereof (i.e., embossed), wherein the polymer film comprises a polyvinyl chloride polymer comprising at least about 25% plasticizer content by weight. In some embodiments, the first outer surface has a gloss of greater than about 80 gloss units. In other embodiments, the polymer comprises from about 25% to about 35% plasticizer by weight.

Other representative self-clinging films are described in U.S. Pat. No. 5,698,621, the full disclosure of which is hereby incorporated by reference it its entirety. The PVC resins used to prepare the PVC films will generally have a degree of polymerization (“p”) which is between 650 and 1600, (e.g., between 900 and 1100), and an inherent viscosity (“i.v.”) between 0.6 and 1.2 (based on ASTM D-1243). The PVC-based polymers of the present invention may be formulated from a single PVC resin or a mixture of two or more different PVC resins. When two or more different PVC resins are used, the PVC resins preferably have degrees of polymerization which are relatively close in value.

The films of the present disclosure may comprise one or more plasticizers, for example a primary plasticizer and/or a general plasticizer. The primary plasticizer serves to provide flexibility to the film and includes, but is not limited to, the following compounds: butyl benzyl phthalate (BBP), bis-2-methoxyethyl phthalate (BMEP), trixylenyl phosphate (TXP), cresyldiphenyl phosphate (CDPP), cresyldixylenyl phosphate (CDXP), triphenyl phosphate (TPP), tricresyl phosphate (TCP), tris-dichloropropyl phosphate (TDPP), polypropylene glycol polyadipate (PPGPA), polybutylene glycol polyadipate (PBGPA), and mixtures thereof. In some embodiments, the primary plasticizer is present in the film in an amount ranging from 40 to 90 PPHR, preferably from 45 to 73 PPHR, and most preferably from 49 to 61 PPHR.

In addition to the primary plasticizer, general plasticizers may also be present, and can be provided to obtain the desired surface tensions. The general plasticizers of the present invention include, but are not limited to, the following compounds: di-n-octyl phthalate, di-2-ethylhexyl phthalate, dibutyl phthalate, diisononyl phthalate, diisobutyl phthalate, didecyl phthalate, dibenzyl phthalate, dicyclohexyl phthalate, dinonyl phthalate, octylcapryl phthalate, tributyl phosphate, triethyl phosphate, trichloroethyl phosphate, trioctyl phosphate, tris-isopropylphenyl phosphate, dibutyl sebacate, dioctyl sebacate, triacetyl glycerine, glycerol sebacate, diisodecyl succinate, diisodecyl adipate, di-n-butyl maleate, tri-n-butyl citrate, methylacetyl riconolate, butyl oleate, glycerin monoricinolate, trimellitates, chloride paraffin, and mixtures thereof. The ratio of primary plasticizer to general plasticizer is typically greater than 1:1 (in other words, the general plasticizer is preferably less than 50% of the total amount of primary and general plasticizer).

In certain embodiments, the films (i.e., polymers used to prepare the polyolefin and/or PVC films) comprise a stabilizer. The stabilizers of the present invention include metal soaps, organic phosphites, epoxy compounds, tin stabilizers, and mixtures thereof. The stabilizers can provide protection against deficient PVC homopolymerization and copolymerization, and functions to eliminate or slow down the process of polymer degradation. The total amount of stabilizer present in the films ranges from 0.1 to 10 PPHR, preferably from 1 to 7 PPHR, and most preferably 2 to 5 PPHR. In some embodiments, the stabilizer is a mixture of metal soaps and epoxy compounds, or a mixture of metal soaps, epoxy compounds and organic phosphites.

Metal soap stabilizers include zinc stearate, barium stearate, calcium stearate, cadmium stearate, barium ricinolate, calcium oleate, calcium laurelate, zinc octoate, and mixtures thereof. In some embodiments, the metal soap stabilizers are mixtures of barium stearate, zinc stearate and cadmium stearate. An exemplary barium stearate/zinc stearate mixture is sold by Bearlocher (Chemgrade UBZ-791), and preferred calcium stearate/zinc stearate and barium stearate/cadmium stearate mixtures are sold by Azko Interstab (CZ-19A and BC-103L, respectively).

Epoxy compound stabilizers include epoxy soybean oil (“ESO”), epoxy linseed oil, epoxy polybutadiene, epoxy methylstearate, epoxy stearate, epoxy ethylhexyl stearate, epoxy stearyl stearate, epoxy propyl isocyanalate 3-(2-case INO)-1,2-epoxy propane, epoxy-bis-phenol A didiglycyzyl ester, vinyl dicyclohexanediepoxide, 2,2-bis-(4-hydroxyphenol) propane and epichlorohydrine condensation copolymeration, and mixtures thereof.

Organic phosphite stabilizers include diphenyldecyl phosphite, triphenyl phosphite, tris-nonylphenyl phosphite, tri-steareal phosphite, octyldiphenyl phosphite, and mixtures thereof. Tin stabilizers include tin dilaurate, dibutyl tin maleate, organic tin mercaptide and organic tin sulfonic amide, and mixtures thereof.

The above stabilizers may be used individually or in any combination. Preferably, the stabilizers of the present invention are mixtures of zinc stearate, barium stearate, calcium stearate, and epoxy compounds. A preferred epoxy stabilizer is epoxy soybean oil. In addition, organic phosphites may be used in conjunction with the zinc stearate, barium stearate, cadmium stearate, and epoxy compound mixtures. Particularly preferred stabilizer mixtures are barium stearate/zinc stearate and ESO, calcium stearate/zinc stearate and ESO, and barium stearate/cadmium stearate and ESO.

The films may also include additional additives, such as anti-static agents, anti-fogging agents, ultra-violet inhibitors, anti-oxidants, light stabilizers, fire retardants, pigments, and mixtures thereof. These additives are generally known in the art and may be present in the films in an amount sufficient to impart the desired property (generally below 10 parts per hundred (PPHR)).

Anti-static and anti-fogging agents include sorbitan fatty ester, sorbitol fatty ester, glycerine fatty ester, diglycerine fatty ester, diglycerine fatty dibasic ester and glycerine fatty dibasic ester (often in combination with ethylene oxide, propylene oxide, butylene oxide and other alkene oxides). For example, the following commercial compounds may serve as anti-static and anti-fogging agents: sorbitan palmitate, sorbitan stearate, sorbitan stearate-ethylene oxide (2 mol.), sorbitan stearate-propylene oxide (3 mol.), sorbitol stearate, sorbitol stearate-propylene oxide (3 mol.), diglycerine palmitate, diglycerine stearate, glycerine stearate, glycerine palmitate-ethylene oxide (2 mol.), sorbitan stearate-adipate-ethylene-ethylene oxide (3 mol.), sorbitol stearate-adipate-ethylene oxide (2 mol), diglycerine-palmitate-sebacate-propylene oxide (3 mol.), sorbitol palmitate-adipate (3 mol.), and mixtures thereof.

Ultraviolet inhibitors include hydroquinone disalicylates and phenylsalicylate, paraoctylphenylsalicylate, 2,2′-hydroxy-4-methoxy benzophenone, 2,2′-hydroxy-4,4′-dimethoxy benzo-phenone, 2-(2′-hydroxy-5′-methylphenyl)benzyltriazol, 2-(2′-hydroxy-5′-methylphenyl)-5,6-dichlorobenzyltriazol, cyanoacrylate, and mixtures thereof. Anti-oxidants include phenols, thiopropanoates and fatty sulfites, and mixtures thereof. Light stabilizers include 4-(phenyllacetoxy)-2,2,6,8,-tetrametylpiperazine, tris-(2,2,6,6,-tetramethyl-4-piperazyl)triazine-2,4,6-tricarboxylates, and mixtures thereof.

### Preparation of the Films

The films can be prepared using calendering and/or casting techniques. Such methods are included within the scope of the invention. FIG. 2 illustrates an exemplary procedure 200 for preparation of the films. Briefly, polyolefin compositions 201, 202, 203 are added to extrusion die head 204. The polyolefin compositions can be purchased from commercial sources or prepared according to polymerization techniques known in the art. The three polyolefin compositions are co-extruded through extrusion die 205 onto casting roll 206. The cast film is generally passed over one or more cooling rolls 207, 208 before being passed to take off roll 209. The surface of the polyolefin films can be tailored to the desired end application. For example, after preparing the films according to the above described extrusion/casting process, a surface of the films (e.g., the outer surface of the first polyolefin layer) can be treated to obtain the desired gloss and/or surface tension. Such treatment includes corona or plasma treatment or other techniques known in the art. As shown in FIG. 2, the cast film can be passed through a corona and/or plasma treatment station 210 to impart a high gloss on the outer surface of the first polyolefin layer. The films can be stored in rolls or other convenient forms until use.

Accordingly, in one embodiment the present disclosure provides a method for preparing the disclosed polyolefin films, the method comprising:

A) co-extruding first, second and third polyolefin compositions onto a die head block; and

B) casting the co-extruded mixture to obtain the polyolefin film.

In some embodiments, the method further comprises subjecting at least one surface of the polyolefin film to corona or plasma treatment.

The self-clinging films can be prepared using processes which include extrusion, calendering and optional embossing. An exemplary method for preparing self-clinging films 300 is illustrated in FIG. 3. In the illustrated method, resins are formulated by combining a PVC-based resin, primary plasticizer(s), stabilizer(s), and optional additives in the amounts specified above. This formulation is then mixed by a Hi-speed mixer and/or a Banbury intensive mixer. The mix is then calendered through calender rolls 301 and/or extruded to a film having a thickness ranging from about 0.002 inch to about 0.02 inch, preferably from about 0.003 inch to about 0.01 inch, and most preferably from about 0.004 inch to about 0.008 inch. Calendering and extrusion processes for forming PVC film are well known in the art (see Encyclopedia of PVC, Leonard L. Nass ed., Marcel Dekker, Inc. pub., pp. 1251-1312 and 1361-1414, 1977) (incorporated herein by reference).

After calendering, the PVC film is run through take off rolls 302 and brought into contact with a polyolefin film of the invention 303 (typically provided in the form of a roll as depicted in FIG. 3). The self-clinging surface of the PVC film 304 is contacted with the outer surface of the first polyolefin layer 305 (i.e., the high gloss side) and passed through rolls 306, 307 to ensure intimate contact (e.g., lamination) with the polyolefin film. In some embodiments, roll 307 is provided as a rubber roll.

In certain embodiments, one surface of the self-clinging film is embossed. Such films are prepared by a slight modification to the above scheme. Namely, roll 306 is modified to contain a pattern or texture (i.e., roll 306 is an embossing roll). Thus, as the PVC film passes through roll 306, the self-clinging surface becomes adhered to the high gloss surface of the polyolefin film and the other surface becomes embossed. The composite film (i.e., polyolefin film adhered to PVC film) can then be stored in rolls or other convenient form until used.

In some specific embodiments, the method for preparing the article which comprises the polyolefin film adhered to the PVC film comprises:

A) providing any of the disclosed polyolefin films;

B) extruding a composition comprising polyvinyl chloride onto a calendering head;

C) calendering the extruded composition to obtain a polyvinyl chloride film having a self-clinging surface; and

D) contacting (e.g., laminating) the polyolefin film with the extruded composition either during or after step C),

wherein the high gloss surface of the polyolefin film is contacted with the self-clinging surface.

In certain other embodiments, the method further comprises passing the polyvinyl chloride film and the polyolefin film through an embossing station, wherein the polyvinyl chloride film is brought into contact with the polyolefin film prior to, or at the same time as, passing the polyvinyl chloride film and the polyolefin film through the embossing station.

The PVC films may also be printed with various designs or lettering by known techniques. Inks which find particular application to the PVC film of the present invention are oil-, alcohol-, water- and solvent-based inks Standard printing methods include Flexo, Offset, Screen and Gravure (see Technical Guide Book of the Screen Printing Industry, SPAI (Screen Printing Association Int'l) pub., Section K6, pp. 1-4, 1984) (incorporated herein by reference).

The following examples are provided to illustrate selected embodiments of the invention and are not to be construed as limiting its scope.

### EXAMPLES

### Example 1

A polypropylene film was prepared according to the above described general procedures. The film was tested and found to have the following properties:

TABLE 1
Properties of a Representative Polyolefin Film

| Property | Result* | |
|---|---|---|
| Average gauge | 7.8 | mil |
| Tensile Strength at Break | 4600 | PSI (MD) |
| (ASTM D-882) | 4190 | PSI (TD) |
| Elongation | 1127% | (MD) |
| (ASTM D-882) | 955% | (TD) |
| Secant Modulus | 91 | ksi (MD) |
| (ASTM D-882) | 86 | ksi (TD) |
| Surface Tension | 38 | dynes/cm (in) |
| | 32 | dynes/cm (out) |
| Elmendorf Tear | 38 | (MD) |
| (ASTM D-689) | 54 | (TD) |
| Dimensional Stability at | −0.4 | (MD) |
| 100° F. (ASTM D-1204) | 0.0 | (TD) |

| | |
|---|---|
| Shore D | 60.0 |
| (ASTM D-2240) | |
| Gloss | 83 (outer surface of “1^{st} polyolefin layer”) |
| (BYK Gloss Meter) | 7 (outer surface of “2^{nd} polyolefin layer”) |

*“MD” indicates measurement was taken in the machine direction (i.e., the direction in which the film is passed through the casting rolls). “TD” indicates measurement was taken in the direction transverse to the machine direction.

All of the U.S. patents, U.S. patent application publications, U.S. patent applications, foreign patents, foreign patent applications and non-patent publications referred to in this specification or application data sheet are incorporated herein by reference, in their entirety to the extent not inconsistent with the present description.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A polyolefin film comprising:
A) a first polyolefin layer having an outer surface with a gloss of greater than about 60 gloss units;
B) a second polyolefin layer having an outer surface with a gloss of less than about 25 gloss units; and
C) a polyolefin support layer interposed between the first and second polyolefin layers,
wherein the polyolefin film has a total thickness ranging from about 0.005 inches to about 0.015 inches, and the thickness of each of the first and second polyolefin layers independently ranges from about 1% to about 20% of the total thickness of the polyolefin film.

2. The polyolefin film of claim 1, wherein the total thickness of the polyolefin film ranges from about 0.007 inches to about 0.011 inches.

3. The polyolefin film of claim 1, wherein the total thickness of the polyolefin film is about 0.008 inches.

4. The polyolefin film of claim 1, wherein the outer surface of the first polyolefin layer has a gloss of greater than about 75 gloss units.

5. The polyolefin film of claim 1, wherein the outer surface of the first polyolefin layer has a gloss of greater than about 80 gloss units.

6. The polyolefin film of claim 1, wherein the outer surface of the second polyolefin layer has a gloss of less than about 15 gloss units.

7. The polyolefin film of claim 1, wherein the outer surface of the second polyolefin layer has a gloss of less than about 8 gloss units.

8. The polyolefin film of claim 1, wherein the outer surface of the first polyolefin layer has a surface tension of greater than about 33 dynes/cm as determined by ASTM D 2578.

9. The polyolefin film of claim 1, wherein the outer surface of the first polyolefin layer has a surface tension ranging from about 33 dynes/cm to about 43 dynes/cm as determined by ASTM D 2578.

10. The polyolefin film of claim 1, wherein the outer surface of the first polyolefin layer has a surface tension of about 38 dynes/cm as determined by ASTM D 2578.

11. The polyolefin film of claim 1, wherein the outer surface of the second polyolefin layer has a surface roughness ranging from about 1 μm to about 10 μm.

12. The polyolefin film of claim 1, wherein the outer surface of the second polyolefin layer has a surface roughness of about 5 μm.

13. The polyolefin film of claim 1, wherein the second polyolefin layer comprises a cross-linked polyolefin.

14. The polyolefin film of claim 1, wherein the second polyolefin layer comprises a thermoplastic polyolefin polymer.

15. The polyolefin film of claim 1, wherein the second polyolefin layer comprises a copolymer of a polyolefin and rubber.

16. The polyolefin film of claim 1, wherein the second polyolefin layer comprises a metallocene polypropylene polymer.

17. The polyolefin film of claim 1, wherein the first polyolefin layer comprises a random polymer.

18. The polyolefin film of claim 1, wherein the support layer comprises recycled polyolefin.

19. The polyolefin film of claim 18, wherein the support layer comprises up to about 30% recycled polyolefin.

20. The polyolefin film of claim 1, wherein the support layer comprise comprises a filler.

21. The polyolefin film of claim 20, wherein the polyolefin film comprises up to about 70% by weight of the filler.

22. The polyolefin film of claim 21, wherein the polyolefin film comprises from about 50% to about 60% by weight of the filler.

23. The polyolefin film of claim 20, wherein the filler is selected from CaCO₃, clay, BaSO₄, talc and MgCO₃.

24. The polyolefin film of claim 1, wherein the support layer comprises a low density polyethylene.

25. The polyolefin film of claim 1, wherein the thickness of the first polyolefin layer is about 10% of the total thickness of the polyolefin film.

26. The polyolefin film of claim 1, wherein the thickness of the second polyolefin layer is about 5% of the total thickness of the polyolefin film.

27. The polyolefin film of claim 1, wherein the thickness of the polyolefin support layer is about 85% of the total thickness of the polyolefin film.

28. The polyolefin film of claim 1, wherein at least one of the first polyolefin layer, the second polyolefin layer or the polyolefin support layer comprise polypropylene.

29. The polyolefin film of claim 1, wherein each of the first polyolefin layer, the second polyolefin layer and the polyolefin support layer comprise polypropylene.

30. A method for preparing the polyolefin film of claim 1, the method comprising:
A) co-extruding first, second and third polyolefin compositions onto a die head block; and
B) casting the co-extruded mixture to obtain the polyolefin film.

31. The method of claim 30, further comprising subjecting the polyolefin film to corona or plasma treatment.

32. An article comprising the polyolefin film of claim 1 in contact with a polyvinyl chloride film, wherein:
A) the polyvinyl chloride film comprises a self-clinging first outer surface; and
B) the first outer surface of the polyolefin film is in contact with the self clinging surface of the polyvinyl chloride film.

33. The article of claim 32, wherein the polyvinyl chloride film further comprises a second outer surface comprising raised or recessed relief images, designs or patterns, or combinations thereof.

34. The article of claim 32, wherein the outer surface of the first polyolefin film and the self-clinging surface of the polyvinyl chloride film have compatible surface tensions.

35. The article of claim 32, wherein the surface tension of the self-clinging surface of the polyvinyl chloride film ranges from about 30 dynes/cm to about 38 dynes/cm.

36. The article of claim 35, wherein the surface tension of the self-clinging surface of the polyvinyl chloride film is about 34 dynes/cm.

37. The article of claim 32, wherein the article is in the form of a cylindrical roll.

38. The article of claim 33, wherein the article is in the form of a cylindrical roll, such that the embossed surface is in contact with the second outer surface of the polyolefin film.

39. A method for preparing the article of claim 32, the method comprising:
A) providing the polyolefin film of claim 1;
B) extruding a composition comprising polyvinyl chloride onto a calendering head;
C) calendering the extruded composition to obtain a polyvinyl chloride film; and
D) contacting the polyolefin film with the extruded composition either during or after step C).

40. The method of claim 39, further comprising passing the polyvinyl chloride film and the polyolefin film through an embossing station, wherein the polyvinyl chloride film is brought into contact with the polyolefin film prior to, or at the same time as, passing the polyvinyl chloride film and the polyolefin film through the embossing station.

41. A self-clinging polymer film comprising first and second outer surfaces, wherein the first outer surface has a gloss of greater than about 75 gloss units, and the second outer surface comprises raised or recessed relief images, designs or patterns, or combinations thereof, wherein the polymer film comprises a polyvinyl chloride polymer comprising at least about 25% plasticizer content by weight.

42. The polymer film of claim 41, wherein the first outer surface has a gloss of greater than about 80 gloss units.

43. The polymer film of claim 41, wherein the polymer comprises from about 25% to about 35% plasticizer by weight.
